(19) United States
(12) Patent Application Publication
(10) Pub. No.: US 2011/0156998 A1
(43) Pub. Date: Jun. 30, 2011

(54) METHOD FOR SWITCHING TO DISPLAY THREE-DIMENSIONAL IMAGES AND DIGITAL DISPLAY SYSTEM

(75) Inventors: Shih-Ting Huang, Taipei Hsien (TW); Chueh-Pin Ko, Taipei Hsien (TW)

(73) Assignee: ACER INCORPORATED, Taipei Hsien (TW)

(21) Appl. No.: 12/732,527

(22) Filed: Mar. 26, 2010

(30) Foreign Application Priority Data
Dec. 28, 2009 (TW) 98145377

(51) Int. Cl. G06T 1/00; G09G 5/00

(52) U.S. Cl. 345/156; 345/522

(57) ABSTRACT

A method for switching to display three-dimensional (3D) images and a digital display system are provided. In the method, a digital display is activated to receive image data comprising at least one image and to detect a triggering signal, which is generated by detecting whether a 3D glasses is being used through a software means or a hardware means. According to the triggering signal, the digital display switches between formats of two-dimensional (2D) image and 3D image, so as to display the images.

### CROSS-REFERENCE TO RELATED APPLICATION

This application claims the priority benefit of Taiwan application serial no. 98145377, filed on Dec. 28, 2009. The entirety of the above-mentioned patent application is hereby incorporated by reference herein and made a part of this specification.

### BACKGROUND OF THE INVENTION

1. Field of the Invention

The present invention is directed to an image display method and a display, and more particular, to a method for switching to display three-dimensional (3D) images and a digital display system.

2. Description of Related Art

The 3D display technique is a mainstream in the current digital display field. No matter for the entertainment, the medical research, or other fields, users pay more attention on a simulated sense like being on spot. In respect of entertainment, the 3D display technique may present a visional effect of an object in the frame shooting toward the viewer and flying out of the screen, which usually brings the simulated sense like being on spot. Accordingly, the 3D display technique has brought a new trend and a development target for the movie and game field. In respect of medical research, conventional medical image is limited to 2D cross-sectional image, such that the doctor may make a misjudgement when diagnosing the image because the image can only present characteristics of one aspect. However, with the assistance of the 3D display technique, the doctor may see all the aspects of the image clearly, thus reducing the misjudgement.

Current 3D display technique can be simply classified into a naked-eye type and a glass type. Wherein, no matter which display type is selected, the user always needs to switch the display mode from an ordinary 2D display mode to the 3D display mode manually every time he wants to see the 3D images. However, in the process of switching, the user still needs to select related settings about the digital display. Otherwise, the 3D display mode may not be activated normally. Such miscellaneous settings may lower the user's pleasure for watching. Therefore, how to reduce the load of the user and help the user to fast switch the viewing mode has become a major issue in the field.

### SUMMARY OF THE INVENTION

The present invention is directed to a method for switching to display 3D images, which can switch between formats of 2D image and 3D image so as to display image.

The present invention is directed to a digital display system, which can detect whether a 3D glasses is being used, and determine whether to switch to display 3D images accordingly.

The present invention provides a method for switching to display 3D images. In the method, a digital display is activated to receive image data comprising at least one image. Then, a triggering signal is detected, and accordingly a display mode is switched between formats of 2D image and 3D image and is used to display the images.

In one embodiment of the invention, the step of detecting the triggering signal comprises detecting whether the 3D glasses is being used, in which the triggering signal is generated when the 3D glasses is detected as being used.

In one embodiment of the invention, the step of detecting whether the 3D glasses is being used comprises using a sensor disposed on the 3D glasses to detect whether the 3D glasses is worn by a user.

In one embodiment of the invention, the aforesaid sensor comprises being disposed on a nose pad portion, an ear hanger portion or a glass clip portion of the 3D glasses so as to detect whether the 3D glasses is worn by the user.

In one embodiment of the invention, the step of detecting whether the 3D glasses is being used comprises using a G-sensor disposed on the 3D glasses to detect whether the 3D glasses is taken by a user.

In one embodiment of the invention, the step of detecting whether the 3D glasses is being used comprises using a switch disposed on a holder of the 3D glasses to determine whether the 3D glasses is being used by the user.

In one embodiment of the invention, the step of detecting whether the 3D glasses is being used comprises capturing a user image, recognizing a face image in the user image through a human face recognition algorithm, and then detecting whether the face image comprises the 3D glasses, so as to determine whether the 3D glasses is being used.

In one embodiment of the invention, the step of switching between the formats of 2D image and 3D image to display the images according to the triggering signal comprises switching the format of the image to 3D image for display when receiving the triggering signal and switching the format of the image to 2D image for display when no triggering signal is received.

In one embodiment of the invention, the step of switching the format of the image to 3D image for display comprises determining the format of the received image is 2D image or 3D image, in which the format of the image is transformed into 3D image and the transformed image is displayed when the format of the image is 2D image, and the image is directly displayed when the format of the image is 3D image.

In one embodiment of the invention, the step of transforming the format of the image into 3D image and displaying the transformed image comprises dividing each image into a left eye image and a right eye image and then simultaneously displaying the divided left eye image and right eye image.

In one embodiment of the invention, the step of switching the format of the image into 2D image for display comprises determining the format of the received image is 2D image or 3D image, in which the image is directly displayed when the format of the image is 2D image, and the format of the image is transformed into 2D image and the transformed image is displayed when the format of the image is 3D image.

The present invention provides a digital display system, which comprises a detection device and a digital display. The detection device is used for detecting whether a 3D glasses is being used and generating a triggering signal accordingly. The digital display is used for receiving image data and switching between the formats of 2D image and 3D image according to the triggering signal so as to display at least one image in the image data.

Based on the above, the method for switching to display 3D images and the digital display system of the present invention detect whether a 3D glasses is worn by a user through hardware means or software means, so as to switch between the format of 2D image and 3D image and display the received image. Accordingly, the present invention may help the user to fast switch the viewing mode.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a digital display system according to an embodiment of the present invention.

FIG. 2 is a flowchart illustrating a method for switching to display 3D images according to an embodiment of the preset invention.

FIG. 3 is a flowchart illustrating a method for switching to display 3D images according to an embodiment of the preset invention.

FIG. 4 is a schematic diagram of a digital display system according to an embodiment of the invention.

FIG. 5 is an example illustrating a disposition of a sensor according to an embodiment of the present invention.

FIG. 6 is an example illustrating a disposition of a sensor according to an embodiment of the present invention.

FIG. 7 is a block diagram of a digital display system according to an embodiment of the present invention.

FIG. 8 is a flowchart illustrating a method for switching to display 3D images according to an embodiment of the preset invention.

FIG. 9(a) and FIG. 9(b) are examples of a 3D glasses according to an embodiment of the present invention.

### DESCRIPTION OF EMBODIMENTS

The present invention provides a concept of automatic detection for activating 3D display. Among numerous 3D display techniques, the present invention provides two concepts for the display techniques of shutter glasses and polarizer glasses, in which a hardware means or a software means is used for detecting a circumstance of usage or detecting whether the 3D glasses is worn by a user, so as to determine whether to activate the 3D display mode and simultaneously change the settings related to 3D display of the equipment such as digital display (e.g. screen or projector), computer, gamer, multimedia player, or television.

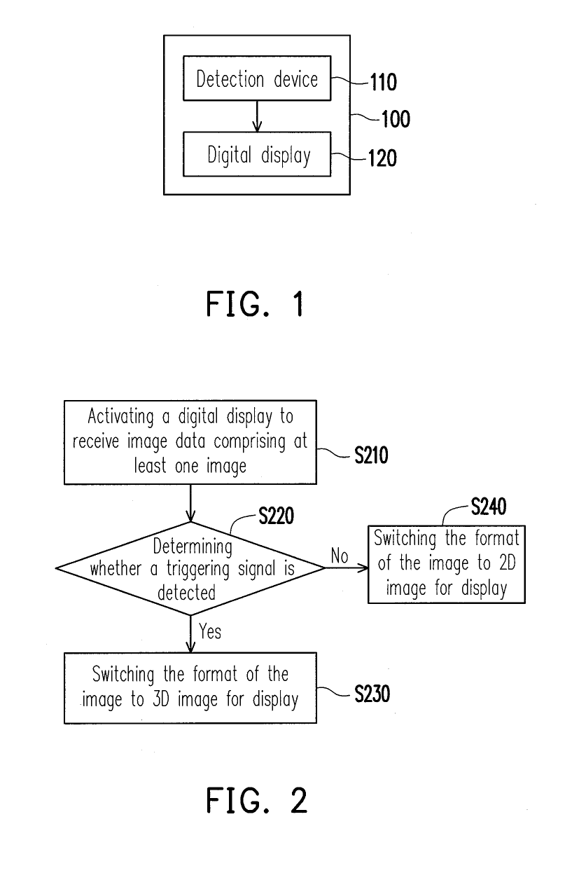

FIG. 1 is a block diagram of a digital display system according to an embodiment of the present invention. Referring to FIG. 1, the present embodiment mainly divides a digital display system 100 into a detection device 110 and a digital display 120. The detection device 110 is used for detecting whether a 3D glasses is being used so as to generate a triggering signal. The digital display 120 switches between formats of 2D image and 3D image according to the triggering signal generated by the detection device 110, so as to display the images in the received image data.

In detail, FIG. 2 is a flowchart illustrating a method for switching to display 3D images according to an embodiment of the preset invention. Referring to FIG. 2, the method of the present embodiment is suitable for the digital display system 100 in FIG. 1 and detailed steps of the switching method of the embodiment are described in detail below with reference to the aforesaid elements of the digital display system 100.

First, when a user activates the digital display 120, the digital display 120 starts to receive image data (step S210). The image data is, for example, a 2D or 3D image, or a video comprises a plurality of 2D or 3D images, which is not limited herein.

Next, the detection device 110 detects a triggering signal (step S220). The digital display system 110 of the present embodiment identifies whether the 3D glasses is being used through a hardware means or a software means, and according determines whether the user wants to activate the 3D display mode. According to different detecting methods, the type of detection device 110 to be used may be varied. In the present invention, the detection device 110 to be used comprises pressure sensor, temperature sensor, G-sensor, switch or digital camera, etc. Embodiments for each type of detection device 110 will be described later and are skipped herein.

Based on the triggering signal generated by the detection device 110, the digital display 120 may switch between formats of 2D image and 3D image, so as to display the received images. In detail, the digital display 120 may switch the format of the received image to 3D image for display when receiving the triggering signal generated by the detection device 110 (step S230). On the contrary, the digital display 120 may switch the format of the received image to 2D image for display when no triggering signal is received (step S240).

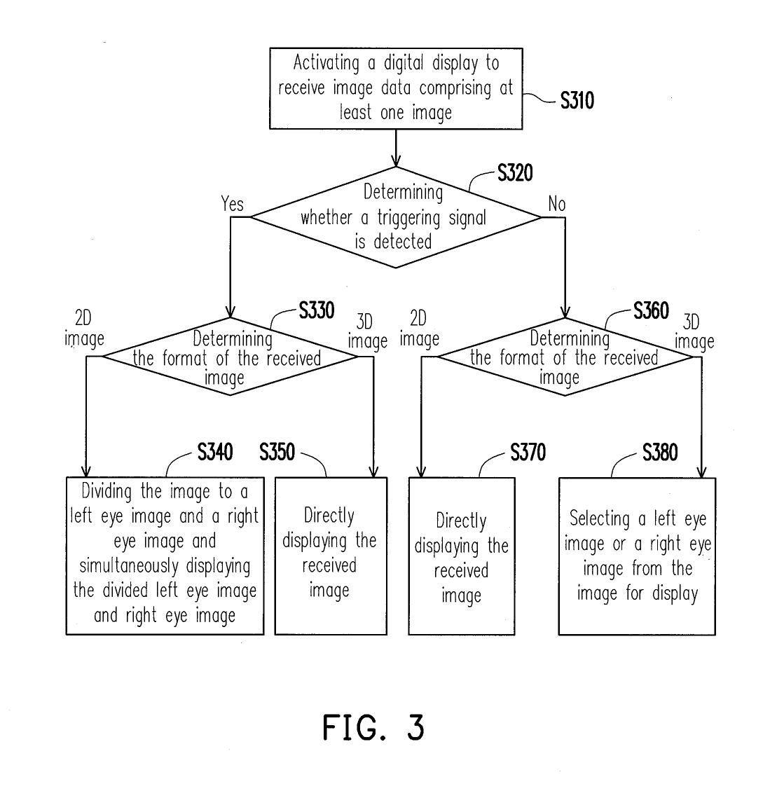

It should be noted herein that the aforesaid image format switching step is executed according to the format of received image. In detail, FIG. 3 is a flowchart illustrating a method for switching to display 3D images according to an embodiment of the preset invention. Referring to FIG. 3, when a user activates the digital display 120, the digital display 120 starts to receive image data (step S310) and the detection device 110 detects a triggering signal (step S320). According to the triggering signal sent by the detection device 110, the digital display 120 can switch to display 3D images or 2D images. The detailed content of the above steps S310-S320 are all identical or similar to the steps S210-S220 in the above embodiment, and will not be described herein.

However, the difference between the present embodiment and the previous embodiments is that, in the present embodiment, when it is required to switch the format of the received images to 3D images, the digital display 120 first determines the format of the received image is the 2D image or 3D image (step S330). If the format of the received image is 2D image, the digital display 120 uses a transformation unit (not shown) to transform the format of image to 3D image, and then displays the transformed image. The digital display 120, for example, divides each of the received images into a left eye image and a right eye image, and then simultaneously displays the divided left eye image and right eye image (step S340), so as to simulate the 3D image. On the contrary, if the format of the received image is 3D image, the digital display 120 directly displays the received image (step S350) without performing the transformation procedure.

On the other hand, when it is required to switch the format of the received image to 2D image, the digital display 120 also needs to determine the received image is the 2D image or the 3D image (step S360). If the format of the received image is the 2D image, the digital display 120 directly displays the received image (step S370). On the contrary, if the format of the received image is 3D image, the digital display 120 uses the transformation unit (not shown) disposed therein to transform the format of the received image into the 2D image, and then displays the transformed image. The digital display 120, for example, selects one of the left eye image and the right eye image from each of the 3D images (step S380), so as to display the 2D image.

Through the aforesaid method for switching to display the 3D images, the present invention may activate the 3D display function to transform the format of images to be displayed when the user takes the 3D glasses, so as to provide the user with ease to view the 3D image. As for how to assure the user has taken the 3D glasses, embodiments are respectively given below for further illustration according to the type of 3D glasses and the method of detection to be used.

In aspect of hardware detection, it is required to cooperate with a sensor or a transmitter and is required to be supplied with electricity. Therefore, the glasses in the method plays an active role, which is suitable for the shutter glasses.

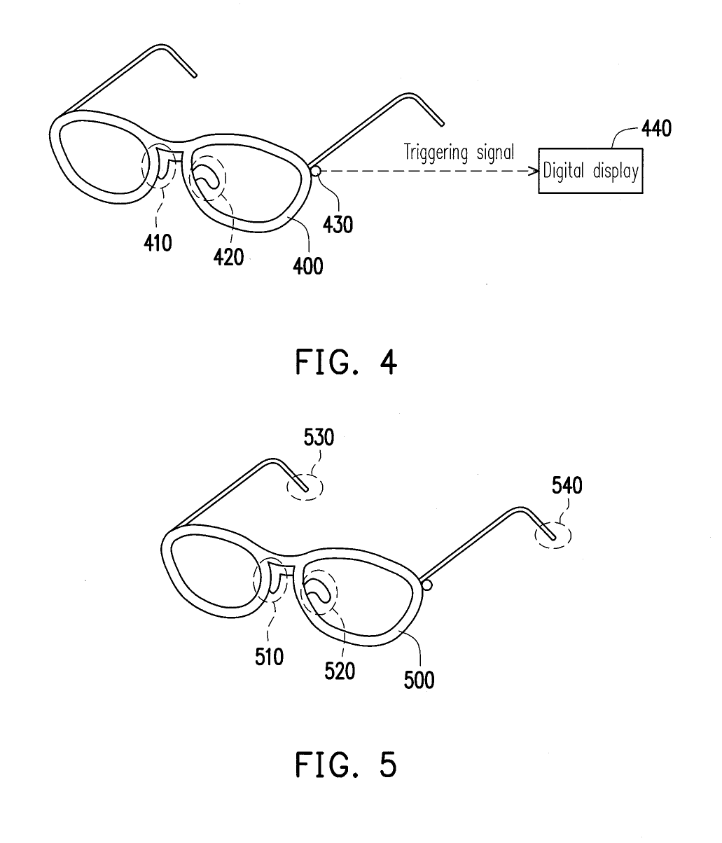

For example, FIG. 4 is a schematic diagram of a digital display system according to an embodiment of the invention. Referring to FIG. 4, the digital display system of the present invention disposes a sensor 410 and a sensor 420 on the 3D glasses 400 for detecting whether the 3D 400 is worn by a user. When the sensor 410 or the sensor 420 detects the wear of the 3D glasses, a triggering signal is transmitted to the digital display 440 through a transmitter 430 disposed on the 3D glasses, so as to control the digital display 440 to switch the format of the images to be displayed.

In detail, the nose pad portion or the ear hanger portion of the glasses contact with the human body while the user wearing the glasses, such that those portions may sense the temperature of the human body, or accept the pressure provided by the human nose or ear. Accordingly, one embodiment of the present invention disposes a pressure sensor or a temperature sensor on the nose pad portion or the ear hanger portion of the 3D glasses, so as to detect whether the 3D glasses is worn by the user and determine whether to switch the format of image to be displayed. When the aforesaid sensor detects that the 3D glasses is worn by the user, a transmitter disposed on the 3D glasses is further used to transmit the triggering signal to the digital display through wireless means such as infrared ray, laser, Bluetooth, or radio frequency, so as to control the digital display to switch the format of the images to be displayed.

For instance, FIG. 5 is an example illustrating a disposition of a sensor according to an embodiment of the present invention. The sensors are rendered in FIG. 5 as being disposed on the nose pad parts 510 and 520 and the ear hanger parts 530 and 540, so as to detect whether the 3D glasses 500 is worn by the user.

It should be noted herein that, in one embodiment, if the user has worn a near-sighted glassed or a far-sighted glasses, the 3D glasses can be designed in a form of independent lens with a glass clip, so as to be clipped on the user's glasses. The sensor of the present invention can be designed in a form of a switch that is disposed on the glass clip and designed in a form similar to a tenon. When the user does not wear the 3D glasses, the lenses of the 3D glasses are not clipped on the user's glasses. At this time, the tenon on the glass clip is under a tight condition which can be regarded as the user not wearing the 3D glasses, and the 3D glasses does not generate or transmit the triggering signal. On the contrary, when the user uses the 3D glasses, the lenses of the 3D glasses are clipped on the user's glasses. At this time, the tenon on the glass clip is under a separate condition (i.e. separated by the lenses of the user's glasses), and it is determined that the user has worn the 3D glasses. At this time, a transmitter disposed on the 3D glasses is used to transmit the triggering signal to the digital display, so as to switch the format of the images to be displayed.

Further, in another embodiment, the 3D glasses can also be designed in a form of flip lenses. The sensor of the present invention may be disposed on an open mechanism of the glass clip. When the lenses are flipped to cover the lenses of the user's glasses, the 3D display mode is activated. On the contrary, when the lenses are raised up, the 3D display mode is not activated.

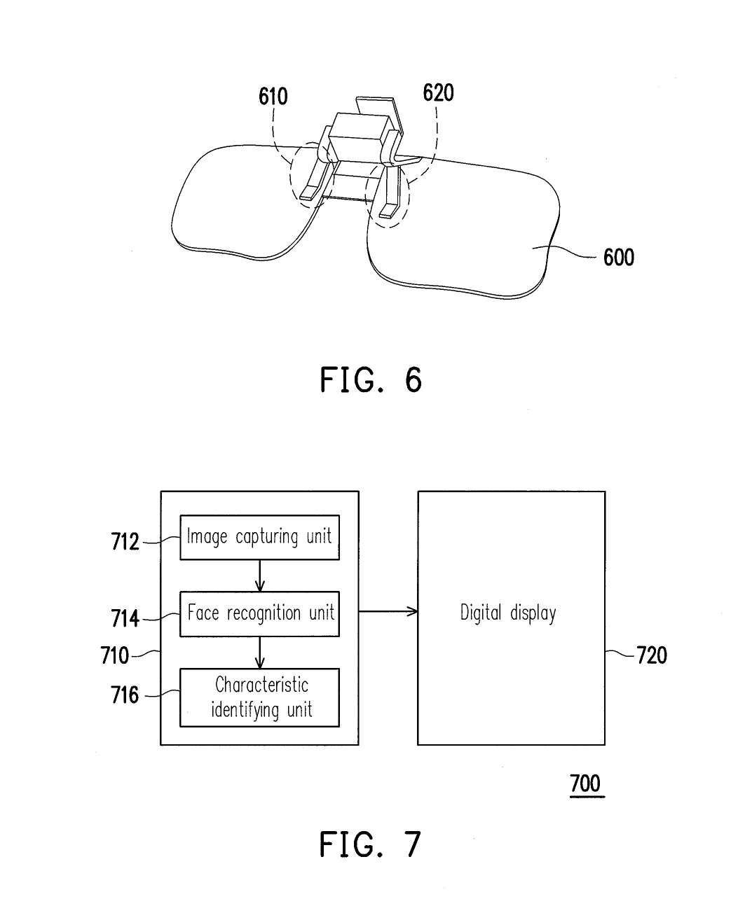

For instance, FIG. 6 is an example illustrating a disposition of a sensor according to an embodiment of the present invention. The sensors are rendered in FIG. 6 as being disposed on the glass clip parts 610 and 620, so as to detect whether the 3D glasses 600 is worn by the user.

It should be noted herein that, in one embodiment, the sensor may also be a G-sensor disposed on the 3D glasses, and used to detect whether the 3D glasses is being taken by a user. When the user takes the 3D glasses and wears it on the face, the G-sensor detects a moving speed and a shift of the 3D glasses right away, in which when the moving speed or the shift exceeds a preset value, then it is determined that the user performs an action of wearing the 3D glasses. At this time, a transmitter disposed on the 3D glasses is further used to transmit the triggering signal to the digital display through a wireless means, so as to control the digital display to switch the format of the images to be displayed.

Further, in one embodiment, the sensor may also be a switch disposed on a holder for placing the 3D glasses, and is used for determining whether the 3D glasses is taken by a user. The holder is, for example, a charger of the 3D glasses. In detail, when the 3D glasses is placed on the holder, the switch is under a status of being pressed and no triggering signal is generated at this time. On the contrary, when the user picks up the 3D glasses, the switch of the holder is flipped to generate the triggering signal, which is then provided for the digital display to switch the format of the images to be displayed.

In respect of software detection, an image processing technique is used for detecting the 3D glasses. Therefore, the glasses applied in the method of the present invention plays a passive role, which is suitable for the polarizer glasses or the Dobly 3D glasses.

For example, FIG. 7 is a block diagram of a digital display system according to an embodiment of the invention. Referring to FIG. 7, the detection device 710 of the digital display system 700 is disposed with an image capturing unit 712, a face recognition unit 714 and a characteristic identifying unit 716, and is used for determining whether the 3D glasses is worn by a user, so as to control the digital display 720 to switch the format of the images to be displayed.

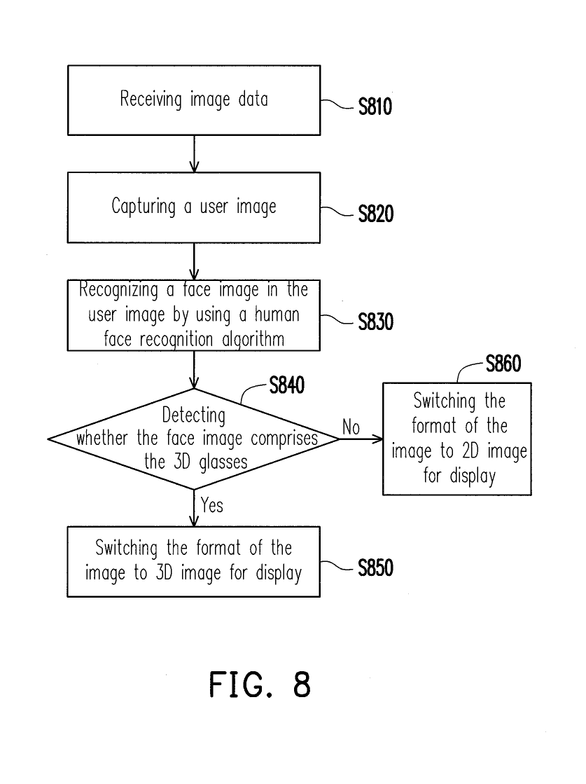

FIG. 8 is a flowchart illustrating a method for switching to display 3D images according to an embodiment of the preset invention. Referring to FIG. 8, the method of the present embodiment is suitable for the digital display system 700 in FIG. 7 and detailed steps of the switching method of the embodiment are described in detail below with reference to the aforesaid elements of the digital display system 700.

First, the digital display 720 receives image data (step S810). The image data is, for example, a 2D or 3D image, or a video comprising a plurality of 2D or 3D images, which is not limited herein.

Next, the image capturing unit 712 captures a user image (step S820), in which the image capturing unit 712 is, for example, a camera or a camcorder using the charge-coupled device (CCD). In the present embodiment, the image capturing unit 712 is used to simulate human eyes and the image processing technique is used to detect whether the user wears the glasses.

In aspect of image processing technique, the face recognition unit 714 recognizes a face image in the user image through a human face recognition algorithm (step S830), and then the characteristic identifying unit 716 identifies whether the face image contains the 3D glasses, so as to determine whether the 3D glasses is being used (step S840).

In detail, the 3D glasses can be disposed with a recognition icon or be designed in a particular style, so as to be provided for the characteristic identifying unit 716 to identify. For example, the frame of the glasses may be designed with a recognizable white color or other colors (e.g. blue) having great difference from a skin color. Further, a barcode or other icons may be marked on the lenses or the frame of the glasses. Regarding the recognition icon or the particular style, the characteristic identifying unit 716 may separate the face image and determine whether the face image contains the recognition icon or contains a glasses in the particular style through an object division method. The characteristic identifying unit 716 may determine the difference between the face images in every time interval, so as to determine whether the user wears the 3D glasses.

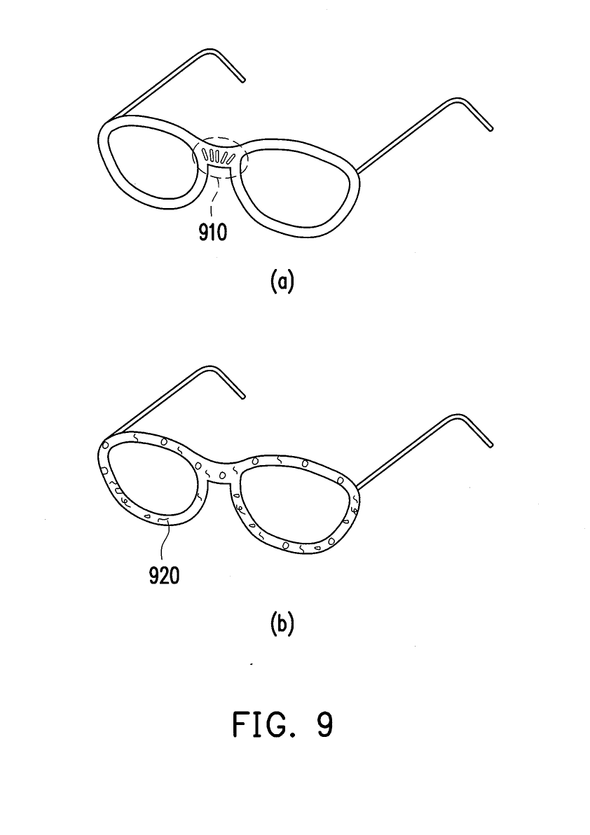

For example, FIG. 9(a) and FIG. 9(b) are examples of a 3D glasses according to an embodiment of the present invention. Wherein, a recognition icon with stripes is disposed on a connection part 910 between the lenses of the 3D glasses in FIG. 9(a), and is provided for the characteristic identifying unit 716 to identify. In addition, a frame part 920 of the 3D glasses depicted in FIG. 9(b) is designed in a particular style, which is also provided for the characteristic identifying unit 716 to identify.

When the characteristic identifying unit 716 identifies that the face image contains the 3D glasses, it represents that the user has worn the 3D glasses. At this time, the detection device 710 generates a triggering signal and transmits the same to the digital display 720, and then the digital display 720 switches the format of the received image to 3D image for display (step S850). On the contrary, if the characteristic identifying unit 716 identifies that the face image does not contain the 3D glasses, it represents that the user does not wear the 3D glasses. At this time, the detection device 710 does not generate the triggering signal and the digital display 720 switches the format of the received image to 2D image for display (step S860).

Through aforesaid method of combining the particular design of the glasses and the image processing, the present invention may reduce the error of the detection and help the user to save the miscellaneous procedures for switching to the 3D display mode.

To sum up, in the method for switching to display 3D images and a digital display system of the present invention, a hardware detection of disposing a sensor on the 3D glasses or the holder for placing the 3D glasses is used, or a software detection of using the image processing technique is used, such that the format of the image to be displayed can be switched to 3D image when the user takes or wears the 3D glasses, so as to achieve the effectiveness of automatically switching the 3D display mode.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for switching to display three-dimensional (3D) images, comprising:
activating a digital display to receive image data comprising at least one image;
detecting a triggering signal; and
switching between formats of two-dimensional (2D) image and 3D image according to the triggering signal so as to display at least one image in the image data.

2. The method according to claim 1, wherein the step of detecting the triggering signal comprises:
detecting whether a 3D glasses is being used; and
generating the triggering signal when the 3D glasses is detected as being used.

3. The method according to claim 2, wherein the step of detecting whether the 3D glasses is being used comprises:
detecting whether the 3D glasses is worn by a user by using a sensor disposed on the 3D glasses.

4. The method according to claim 3, wherein the sensor is disposed on a nose pad portion, an ear hanger portion, or a glass clip portion of the 3D glasses, so as to detect whether the 3D glasses is worn by the user.

5. The method according to claim 2, wherein the step of detecting whether the 3D glasses is being used comprises:
detecting whether the 3D glasses is taken by a user by using a G-sensor disposed on the 3D glasses.

6. The method according to claim 2, wherein the step of detecting whether the 3D glasses is being used comprises:
detecting whether the 3D glasses is taken by a user by using a switch disposed on a holder for placing the 3D glasses.

7. The method according to claim 1, wherein the step of detecting whether the 3D glasses is being used comprises:
capturing a user image;
recognizing a face image in the user image by using a human face recognition algorithm; and
detecting whether the face image comprises the 3D glasses, so as to determine whether the 3D glasses is being used.

8. The method according to claim 1, wherein the step of switching to display the at least one image between the formats of 2D image and 3D image according to the triggering signal comprises:
switching the format of the at least one image to the 3D image for display when receiving the triggering signal; and
switching the format of the at least one image to the 2D image for display when no triggering signal is received.

9. The method according to claim 8, wherein the step of switching the format of the at least one image to the 3D image for display comprises:
determining the format of the at least one image is the 2D image or the 3D image;
transforming the format of the at least one image to the 3D image and displaying the transformed images if the format of the at least one image is the 2D image; and
directly displaying the at least one image if the format of the at least one image is the 3D image.

10. The method according to claim 9, wherein the step of transforming the format of the at least one image to the 3D image and displaying the transformed image comprises:
dividing each of the at least one image to a left eye image and a right eye image; and
simultaneously displaying the divided left eye image and right eye image.

11. The method according to claim 8, wherein the step of switching the format of the at least one image to the 2D image for display comprises:
determining the format of the received at least one image is the 2D image or the 3D image;
directly displaying the at least one image if the format of the at least one image is the 2D image; and
transforming the format of the at least one image to the 2D image and displaying the transformed images if the format of the at least one image is the 3D image.

12. A digital display system, comprising:
a detection device, for detecting whether a 3D glasses is being used and generating a triggering signal accordingly; and
a digital display, for receiving image data and switching between formats of 2D image and 3D image according to the triggering signal so as to display at least one image in the image data.

13. The system according to claim 12, wherein the detection device comprises:
a sensor, disposed on the 3D glasses, for detecting whether the 3D glasses is being used.

14. The system according to claim 13, wherein the sensor is disposed on a nose pad portion, an ear hanger portion, or a glass clip portion of the 3D glasses, so as to detect whether the 3D glasses is worn by a user.

15. The system according to claim 13, wherein the sensor is a G-sensor disposed on the 3D glasses, so as to detect whether the 3D glasses is being taken by a user.

16. The system according to claim 13, wherein the detection device comprises:
a transmitter, for transmitting the triggering signal to the digital display through a wireless means when the sensor detects the 3D glasses is being used, so as to control the digital display to switch to display the at least one image.

17. The system according to claim 12, wherein the detection device comprises:
a switch, disposed on a holder of the 3D glasses for determining whether the 3D glasses is being taken by a user.

18. The system according to claim 12, wherein the detection device comprises:
an image capturing unit, for capturing a user image;
a face recognition unit, for recognizing a face image in the user image by using a human face recognition algorithm; and
a characteristic identifying unit, for detecting whether the face image comprises the 3D glasses, so as to determine whether the 3D glasses is being used.

19. The system according to claim 12, wherein the digital display comprises:
switching the format of the at least one image to the 3D image for display when receiving the triggering signal; and
switching the format of the at least one image to the 2D image for display when no triggering signal is received.

20. The system according to claim 19, wherein the digital display comprises:
a transformation unit, for transforming the format of the at least one image from the 2D image to the 3D image, or from the 3D image to the 2D image for display.
